(19) United States
(12) Patent Application Publication
(10) Pub. No.: US 2008/0227925 A1
(43) Pub. Date: Sep. 18, 2008

(54) Composition containing macrocyclic ethylene isophthalate dimer and process of making

(76) Inventor: Wayne R. Pretzer, Wheaton, IL (US)

Correspondence Address: CLEMENTS BERNARD MILLER, 1901 ROXBOROUGH ROAD, SUITE 300, CHARLOTTE, NC, 28211, US

(21) Appl. No.: 11/724,011

(22) Filed: Mar. 14, 2007

(51) Int. Cl. C08G 63/12; C08G 63/127; C08G 63/49; C08G 63/66

(52) U.S. Cl. 525/386; 528/272; 528/295.5; 528/296; 528/300; 528/301; 528/308

(57) ABSTRACT

The present invention relates to a composition which includes macrocyclic ethylene isophthalate dimer. More specifically, the composition can be:
i) A composition comprising polyhydric alcohol, multi-functional carboxylic acid and macrocyclic ethylene isophthalate dimer;
ii) A multi-arm polyester resin having a polymer containing: a central unit of a multi-functional molecule of either a multi-functional carboxylic acid or a multi-functional polyhydric alcohol, but not both, and arms derived from macrocyclic ethylene isophthalate dimer.
iii) An unsaturated polyester comprising a macrocyclic ethylene isophthalate dimer and one or more polyhydric alcohols, and optionally, one or more aliphatic and/or aromatic acids to form a melt of polymer; then condensing the polymer and one or more ethylenically unsaturated dicarboxylic acids.
   In addition, the field of the present invention comprises a process for preparing the compositions of i) to iii) having macrocyclic ethylene isophthalate dimer, polyhydric alcohol and/or multi-functional carboxylic acid.

### BACKGROUND OF THE INVENTION

1) Field of the Invention

The present invention relates to a composition which includes macrocyclic ethylene isophthalate dimer. More specifically, the composition can be:
i) A composition comprising polyhydric alcohol, multi-functional carboxylic acid and macrocyclic ethylene isophthalate dimer;
ii) A multi-arm polyester resin having a polymer containing: a central unit of a multi-functional molecule of either a multi-functional carboxylic acid or a multi-functional polyhydric alcohol, but not both, and arms derived from macrocyclic ethylene isophthalate dimer; and
iii) An unsaturated polyester comprising a macrocyclic, ethylene isophthalate dimer and one or more polyhydric alcohols, one or more ethylenically unsaturated dicarboxylic acids, one or more ethylenically unsaturated reactive solvents, and optionally, one or more aliphatic and/or aromatic acids.
   In addition, the field of the present invention comprises:
iv) A process for preparing a composition having macrocyclic isophthalate dimer, polyhydric alcohol and/or multi-functional carboxylic acid;
v) A process of preparing a multi-arm polyester resin comprising a macrocyclic ethylene isophthalate dimer and a multi-functional molecule of either a multi-functional carboxylic acid or a multi-functional polyol, but not both, by blending said dimer and said molecule under heated conditions of at least about 100° C. in an inert gas atmosphere;
vi) A process for making unsaturated copolyesters by blending polyester polymers with macrocyclic ethylene isophthalate dimer; and
vii) A process for making a block copolyester by reacting macrocyclic ethylene isophthalate dimer with polyester at a reaction temperature of between 140-220° C.

2) Prior Art

Macropolymers and macromolecules are well known, including cyclic ethylene isophthalates as described in scientific literature. Generally, macrocyclic monomers have been used to prepare polymers through a ring opening polymerization process. Cyclic polyester monomers are attractive because ring opening polymerization is generally not exothermic, does not produce any small molecule coproducts such as water or methanol and is relatively rapid at temperatures lower than typically used for the formation of polyesters from mixtures of multi-functional carboxylic acids and diols.

U.S. Pat. No. 7,151,143 to Wang et al discloses blends containing macrocyclic polyester oligomer and high molecular weight polymer. This application discloses the use of these blends as part of a power coating process. This reference does not explicitly disclose macrocyclic ethylene isophthalate dimers, however it broadly discloses macrocyclic polyester oligomer (see column 7, line 20-26).

U.S. Pat. No. 6,369,157 to Winckler et al discloses blend material including macrocyclic polyester oligomers and processes for polymerizing the same. This patent, like the above noted patent, enjoys a similar inventive entity as assigned to the same corporation. This patent also discloses a process for preparing the blend material, however it does not explicitly disclose macrocyclic ethylene isophthalate dimers, however it broadly discloses macrocyclic polyester oligomers.

U.S. Pat. No. 6,432,486 to Paris et al discloses a coating process that can be used to treat an aircraft surface to prevent icing. The process comprises applying a cyclic prepolymer, including a polyester cyclic prepolymer, to a surface and subsequently ring breaking the cyclic prepolymer to polymerize the cyclic prepolymer. None of the macrocyclic polymers is from ethylene isophthalate cyclic dimers.

In summary, cyclic ethylene isophthalic macromonomers are known in the scientific literature and using macrocyclic polyester oligomers or cyclic prepolymers in blended materials is known as disclosed in the three above identified US patent applications.

### SUMMARY OF THE INVENTION

The present invention relates to blends of macrocyclic ethylene isophthalate dimer with other components to make coatings, for wood or for metal, for example. Additionally, multi-arm, multi-functional polyester resins can be created using the macrocyclic ethylene isophthalate dimer to increase the polymer molecular weight compared to linear polyester while maintaining a comparable viscosity or to reduce the viscosity compared to linear polyesters of similar molecular weight, for example. The macrocyclic ethylene isophthalate dimer can also be employed in blends to make unsaturated polyester by blending the dimer with and one or more polyhydric alcohols, one or more ethylenically unsaturated dicarboxylic acids, one or more ethylenically unsaturated reactive solvents, and optionally, one or more aliphatic and/or aromatic acids. And, lastly the macrocyclic ethylene isophthalate dimer can be used in blends to make copolyesters, by blending the dimer with polyester. The use of copolyesters is well known, such as, for example, bottle resin to make plastic beverage bottles.

In the broadest sense, the present invention comprises a composition of polyhydric alcohol, multi-functional carboxylic acid, and macrocyclic ethylene isophthalate dimer. This composition has utility for coating metals or wood.

In the broadest sense, the present invention also comprises a process for preparing a composition having macrocyclic ethylene isophthalate dimer, polyhydric alcohol and multi-functional carboxylic acid.

In the broadest sense, the present invention comprises a multi-arm polyester resin having a polymer containing: a central unit of a multi-functional molecule of either a multi-functional carboxylic acid or a multi-functional polyol, but not both, and arms derived from macrocyclic ethylene isophthalate dimer.

In the broadest sense, the present invention also comprises a process for preparing a multi-arm polyester resin comprising a macrocyclic ethylene isophthalate dimer and either multi-functional carboxylic acid or multi-functional polyol, but not both, by blending said dimer and said molecule under heated conditions of at least about 100° C. in an inert gas atmosphere.

In the broadest sense, the present invention also comprises an unsaturated polyester comprising macrocyclic ethylene isophthalate dimer and one or more polyhydric alcohols, one or more ethylenically unsaturated dicarboxylic acids, one or more ethylenically unsaturated reactive solvents, and optionally, one or more aliphatic and/or aromatic acids.

In the broadest sense, the present invention also comprises a process of making a block copolyester comprising reacting a macrocyclic ethylene isophthalate dimer with polyester at temperatures between 140-220° C.

### DESCRIPTION OF THE PREFERRED EMBODIMENTS

The macrocyclic ethylene isophthalate dimer comprises two isophthalic acid units and two ethylene glycol units alternatively bonded through ester linkages into a ring.

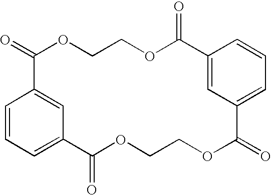

The preparation of macrocyclic ethylene isophthalate dimers can be accomplished by several different methods. The starting diacid in each of the methods would be isophthalic acid and the diol is ethylene glycol. The synthesis solvent can be hexadecane or diphenyl ether. Of course, a suitable replacement for the isophthalate would be its ester equivalent dimethyl isophthalate. So macrocyclic ethylene isophthalate could be prepared by: reacting either isophthalic acid or its ester equivalent dimethyl isophthalate with ethylene glycol in a solvent of either hexadecane or diphenyl ether, at suitable temperatures and pressures.

Lastly, one can start with the oligomer BHEI (bis-hydroxylethyl isophthalate), which can be converted to macrocyclic ethylene isophthalate dimer by heating the BHEI in hexadecane in the present of a titanium catalyst with heavy dilution of the BHEI in the solvent hexadecane. Also, the macrocyclic ethylene isophthalate dimer can be made by heating BHEI in distilled diphenyl ether containing a titanate catalyst.

All these methods are known in the art. See the publication “Macromolecules 2000, Vol. 33, #14, PP 5053-5064”, by Burch, Lustig and Spinu titled “Synthesis of Cyclic Olioesters and Their Rapid Polymerization to High Molecular Weight” is presented. This publication also discloses reacting macrocyclic ethylene isophthalate dimers with a high molecular weight PET melt to give a copolymer-polyethylene terephthalate isophthalate. While this copolymer has the same or similar melting points and crystallization behavior as when the copolymer is formed in the traditional way of feeding terephthalic acid, isophthalic acid and ethylene glycol and conducting a polymerization reaction, it is noted that the ring opening copolymerization of the macrocyclic ethylene isophthalate dimer with the PET occurs at moderate temperatures of about 275° C. to 280° C. as compared to the polymerization temperatures employed in the traditional manner being in excess of 300° C.

To produce some of the compositions of the present invention, useful in coating wood, plastic, composites, or metal, polyhydric alcohol, and/or multi-functional carboxylic acid and macrocyclic ethylene isophthalate dimer is needed. Suitable polyhydric alcohol and multi-functional carboxylic acid are set for the below. Additionally, alkyd coating can be prepared by incorporating fatty acids and/or natural oils with the above compositions.

Polyhydric alcohol is selected from the group consisting of dihydric alcohols containing from 2 to 10 carbon atoms; bis-phenol A; 2,2-[bis-(4-hydroxycyclohexyl)]-propane; 2,2-bis-[4-(2-hydroxyethoxy)]-phenylpropane; polyethylene glycol and derivatives thereof such as diethylene glycol; polypropylene glycol and derivatives thereof; butane diol, cyclopentane diol, cyclohexane diol, neopentyl glycol, trimethylol ethane; trimethylol propane; pentaerythritol; di-pentaerythritol; glycerol, polyethylene oxides; polypropylene oxides; and trimethylol propane polymers; or a mixture of two or more of these. Suitable dihydric alcohols containing from 2 to 10 carbon atoms are selected from the class of ethylene glycol; 1,2-propylene glycol; 1,3-propanediol; 1,3-butanediol; 1,4-butanediol; 1,2-butanediol; 2,3-butanediol; 1,6-hexanediol; 2,5-heaxnediol; 1,3-hexanediol; 1,2-hexanediol; diethylene glycol; dipropylene glycol; triethylene glycol; tripropylene glycol; tetraethylene glycol; 2,2-dimethyl-1,3-propanediol; 2-methyl-1,3-propanediol; 2-butyl-2-ethyl-1,3-propanediol; 2,2,4-trimethyl-1,3-pentanediol; 1,4-cyclohexanediol; 1,4-cyclohexanedimethanol; hydroxypivalyl hydroxypivalate; 1,5-pentanediol; 1,3-pentanediol; 1,2-pentanediol; 1,7-heptanediol; 1,8-octanediol; 1,3-octanediol; 1,2-octanediol; 1,9-nonanediol; 1,10-decanediol; 1,3-decanediol; 1,2-decanediol; 3-methyl-1,5-pentanediol; 3,3-dimethyl-1,2-butanediol; 2-methyl-1,3-pentanediol; 2-methyl-2,4-pentanediol; 3-hydroxymethyl-4-heptanol; and 2-hydroxymethyl-2,3-dimethyl-1-pentanol. This class includes diols and polyols as noted herein.

Multi-functional carboxylic acid is selected from the group consisting of aliphatic diacids containing from 4 to 13 carbon atoms; aromatic dicarboxylic acids containing from 8 to 17 carbon atoms; tricarboxylic acids containing from 6 to 13 carbon atoms, and tetracarboxylic acids containing from 8 to 14 carbon atoms; or a mixture of two or more of these. Suitable multi-functional acids are selected from the class of succinic acid; glutaric acid; adipic acid; pimelic acid; suberic acid; azelaic acid; sebacic acid; tetrahydrophthalic acid; 1,2-cyclohexanedicarboxylic acid; 1,4-cyclohexanedicarboxylic acid; 1,10-decanedicarboxylic acid; 1,11-undecanedicarboxylic acid; maleic acid; fumaric acid; phthalic acid; isophthalic acid; terephthalic acid; benzophenonedicarboxylic acid; 4,4′-dicarboxydiphenyl ether; 2,2′-biphenyldicarboxylic acid; 4,4′-biphenyldicarboxylic acid; 2,6-naphthalenedicarboxylic acid; and 1,4-naphthalenedicarboxylic acid; hemimellitic acid; trimellitic acid; trimesic acid; pyromellitic acid; succinic anhydride; maleic anhydride; phthalic anhydride; trimellitic anhydride; pyromellitic anhydride; or a mixture of two or more of these. Of course the ester equivalent of the multi-functional acids may also be employed, as well as various anhydrides. For example dimethylterephthalate or dimethylisophthalate may be employed in part or if full for terephthalic acid or isophthalic acid, respectively. For succinic acid you may substitute in part or in full for succinic anhydride.

The polyhydric alcohol, and/or multi-functional carboxylic acid, and macrocyclic ethylene isophthalate dimer are blended at a temperature of 140 to 240° C., in an inert gas atmosphere, and optionally in the presence of a metal catalyst. The reaction time occurs until an acid number between about 5 and 40 is achieved, depending on the use of the composition and the curing agent that is used. For example a resin for a polyester-urethane coating may have a low acid number between 5 and 10, while for some powder coating applications the polyester resin may have an acid number between 30 and 40.

The inert gas atmosphere may be any gas or blend of gasses that are inert to the reactions taking place. Nitrogen is the preferred inert gas, but other gasses are known in the art may be suitable.

Suitable catalyst for the above reactions is selected from tin (II), tin (IV), distannoxanes, antimony, or titanium compounds, or a mixture of two or more of these. Suitable tin catalysts include hydrated monobutyl tin oxide, n-butyl tin trioctoate, butyl stannoic acid, dibutyltin diacetate, and other tin catalysts known in the market as FASCAT® catalysts from Arkema, Inc. Suitable titanium catalyst are available in the market place under the name Tyzor® catalysts from DuPont. The amount of catalyst employed depends on the type, but generally is from about 6 ppm to about 500 ppm of the reactants set forth above. Sometimes a mixture of catalyst can be beneficial.

For alkyd resins a fatty acid is generally needed and suitable fatty acids are one or more fatty or other carboxylic acids used to prepare alkyd resins including capric acid, linoleic acid, benzoic acid, dehydrated castor oil fatty acids, heat-bodied soya oil fatty acids, tung oil fatty acids, linseed oil fatty acids, safflower oil fatty acids, soya oil fatty acids, and tall oil fatty acids, or a mixture of two or more of these.

Prior art uses for the macrocyclic ethylene isophthalate dimer have generally focused on the preparation of PEI homopolymer or copolyester with PET, i.e., poly(ethylene terephthalate-co-isophthalate). These polymers are thermoplastics and typically have relatively high molecular weights (M_{w}>5000).

The macrocyclic ethylene isophthalate dimer can be an intermediate in the preparation of polyester and alkyd resins for coating applications. These resins are usually of low molecular weight (M_{w}<5000) and are reactive and form thermoset, crosslinked materials when cured during use. Suitable curing agents for carboxyl functional polyester resins include multifunctional epoxy resins, including, but not limited to, glycidyl ethers of novolacs, trisphenols, and triglycidylisocyanuarate, epoxy resins made by polymerizing epoxy functional monomers such as glycidyl acrylate or glycidyl methacrylate with acrylic, methacrylic, or styrenic monomers; and multi-functional hydroxyalkylamides such as Primid XL-552 (EMS-PRIMID). Suitable curing agents for hydroxyl functional polyesters (polyester polyols) include polyisocyanates and amino-formaldehyde resins. The isophthalic content of the macrocyclic ethylene isophthalate dimer comprises about 85% by weight of the molecule and is an attractive vehicle for introducing isophthalic structure to a resin. Performance benefits provided to many polyester coating resins by the isophthalic moiety include: improved hardness, flexibility, weatherability, and fast cure in waterborne, powder, and coil coatings; enhanced hydrolytic stability to improve the shelf life of waterborne coatings; and decreased dry times for high solids and traditional solvent-borne coatings. The resins of the present invention can be formulated into coatings that include one or more additives such as catalysts, fillers, flow control agents such as Resiflow PV5 (worlee), Modaflow (Cytec), Arconal 4F (BASF), etc., degassing agents such as benzoin (BASF), etc., UV-light absorbers, hindered amine light stabilizers, antioxidants, and dyes and pigments.

Anticipated benefits arising from use of macrocyclic ethylene isophthalate dimer in resin synthesis include: 1) minimal generation of heat as macrocyclic ethylene isophthalate dimer is incorporated into the resin, 2) lower reaction temperature is required to incorporate macrocyclic ethylene isophthalate dimer into a resin compared to using free isophthalic acid and ethylene glycol; significant reactivity is anticipated at 180-200° C. for macrocyclic ethylene isophthalate dimer compared to 240-260° C. for conventional synthesis using the free monomers, 3) shorter reaction and processing time because no low molecular weight molecules, like water, are produced during incorporation of macrocyclic ethylene isophthalate dimer; the presence of water causes a “back” or “reverse” reaction to free monomers (due to the facile equilibrium between polyester and water versus free carboxylic acids and alcohols/polyols) and prevents the reaction from proceeding to completion; removal of small amounts of water from the reaction mixture is a diffusion controlled process that greatly increases batch reaction time for conventional resin manufacture.

Formulating with macrocyclic ethylene isophthalate dimer requires adjustment beyond just substituting an equivalent amount of macrocyclic ethylene isophthalate dimer for isophthalic acid in a given resin formulation. The macrocyclic ethylene isophthalate dimer is neither carboxyl (acid) functional nor hydroxyl functional. However, the macrocyclic ethylene isophthalate dimer can react with either carboxyl or hydroxyl functional molecules and the resulting, larger molecule will retain the functionality of the species reacting with the macrocyclic ethylene isophthalate dimer, i.e. a carboxyl functional molecule will react with macrocyclic ethylene isophthalate dimer to give a larger molecule that is also carboxyl functional; similarly, a hydroxyl molecule will react with macrocyclic ethylene isophthalate dimer to yield a hydroxyl functional species. Thus, if a carboxyl functional final polymer is desired, then the starting formulation must comprise initially an appropriate excess of carboxyl equivalents in addition to the macrocyclic ethylene isophthalate dimer. The extent of the carboxyl excess will, of course, determine the final molecular weight and acid number of the finished resin. Similar reasoning is applied to formulate and prepare hydroxyl functional resins incorporating macrocyclic ethylene isophthalate dimer.

Polyester resin formulations incorporating macrocyclic ethylene isophthalate dimer can use all of the monomers typically used to prepare polyester resins for coating applications. Listings (without limitation) of suitable diols, polyols, and polyfunctional carboxylic acids can be found in the prior art, for example see U.S. Pat. No. 6,555,226; U.S. Patent Application 2004/0018311; and U.S. Pat. No. 6,844,072. Branching is often desirable in a coating resin and can be achieved by use of polyols and polyfunctional carboxylic acids possessing functionality ≧3. It is anticipated and recognized that macrocyclic ethylene isophthalate dimer can also be used in formulations with branching agents. Likewise, monofunctional carboxyl and hydroxyl compounds can be used to tailor resin properties and their use in the resin formulations is anticipated for macrocyclic ethylene isophthalate dimer resin formulations.

The use of various catalysts to promote the incorporation of macrocyclic ethylene isophthalate dimer into resins is anticipated. Esterification, transesterification, polycondensation, acidolysis, and alcoholysis catalysts known in the art are expected to show varying degrees of effectiveness in facilitating reactions involving macrocyclic ethylene isophthalate dimer. Tin (II) and tin (IV) compounds (such as the FASCAT products available from Arkema, Inc.), distannoxanes, and titanium compounds (such as the Tyzor® organic titanates available from DuPont) are several examples.

Isophthalic acid is often used in the preparation of polyester powder coating resins. In a two-stage reaction, isophthalic acid is added during the second stage to provide residual carboxyl functionality for crosslinking and to enhance durability and weathering performance of the final coating. So-called “superdurable” powder coatings use a polyester resin comprising isophthalic acid as the predominant acid component in the formulation. These coatings provide even greater durability and weathering performance. The macrocyclic ethylene isophthalate dimer can be used in formulating analogous polyester powder coating resins and could provide the benefit of significantly shorter reaction times for resin production.

The temperature range for the reactions described here is generally between about 140° C. to about 250° C., but usually 140° C. to 220° C., preferably 150° C. to 215° C., and most preferably 160° C. to 210° C. Higher temperatures will favor faster reaction rates and more scrambling/randomization of the monomers (a more uniform distribution of the monomers, i.e., less block copolymers are formed). Reaction pressure also effects the rate of reaction. Generally polycondensation reactions have better rates of reaction when there is a vacuum pressure (subatmospheric) of about 0 to about 70 kPa absolute. To drive a reaction to completion, it may be necessary to remove one or more of the by-products as they are formed, as is well known to those skilled in the art.

### EXAMPLES

The following examples are illustrative of the present invention but the scope of the invention is not meant to be limited to just these prophetic examples.

### Example 1

### Powder Coating Resin

Powder Coating Resin Formulation

| Materials | Parts by weight | Moles |
|---|---|---|
| Terephthalic acid | 1475 | 8.88 |
| Trimellitic anhydride | 62 | 0.323 |
| Neopentyl glycol | 926 | 8.9 |
| macrocyclic ethylene | 284 | 0.74 |
| isophthalate dimer | | |
| Catalyst, hydrated | 1.43 | |
| monobutyl tin oxide | | |

Neopentyl glycol and half of the terephthalic acid are charged to a reactor equipped with agitator, inert gas sparge, thermometer, and appropriate partial condenser. The contents are heated to 140° C. to achieve a slurry of the ingredients and then the remaining terephthalic acid, the trimellitic anhydride, and the esterification catalyst are added. Heating is continued slowly to a maximum temperature of about 240° C. Reaction temperature and inert gas sparge are maintained until an acid number of about 32-38 is reached. The temperature is reduced to 180-190° C. and macrocyclic ethylene isophthalate dimer added. Reaction temperature is maintained until macrocyclic ethylene isophthalate dimer is incorporated into the resin and then the mixture is discharged from the reactor, and the resin product is cooled, and flaked or ground. The resin can be used in powder coatings that are crosslinked with tetra-functional hydroxyalkylamide, or triglycidylisocyanurate. The resin can also be used with epoxy resins in polyester/epoxy hybrid powder coatings (e.g. a 70/30 hybrid coating). Those skilled in the art are familiar with formulating and compounding a powder coating using a polyester powder coating.

### Example 2

### Powder Coating Resin

Powder Coating Resin Formulation

| Materials | Parts by weight | Moles |
|---|---|---|
| Isophthalic acid | 227.7 | 1.37 |
| Adipic acid | 36.5 | 0.25 |
| Neopentyl glycol | 104 | 1.0 |
| Trimethylolpropane | 16.1 | 0.12 |
| macrocyclic ethylene | 538.1 | 1.4 |
| isophthalate dimer | | |
| Catalyst, n-butyl tin | 2.5 | |
| trioctoate | | |

Neopentyl glycol, adipic acid, and isophthalic acid are charged to a reactor equipped with agitator, inert gas sparge, thermometer, and appropriate partial condenser (such as a steam heated partial condenser and water cooled total condenser). The contents are heated to 150-160° C. to achieve a slurry of the ingredients and then trimethyolpropane, and esterification catalyst are added. The reaction mixture is heated slowly to about 220-235° C. Reaction temperature and inert gas sparge are maintained until an acid number of about 150 is reached. The macrocyclic ethylene isophthalate dimer is added and reaction temperature is maintained until macrocyclic ethylene isophthalate dimer is incorporated into the resin and the final acid number is 44-52. The resin is then discharged the mixture from the reactor, cooled, and flakes or ground.

In the resin recipes given above (Resins 1 and 2), all of the components except macrocyclic ethylene isophthalate dimer are initially combined and reacted at typical polycondensation conditions (about 230-240° C.) before the temperature is reduced and macrocyclic ethylene isophthalate dimer added. It is recognized that in some formulations it could be desirable to initially react macrocyclic ethylene isophthalate dimer with the polyols and then to add the other carboxylic acid components. In other formulations, it may be preferred to react macrocyclic ethylene isophthalate dimer with the carboxylic acid components first and then add the polyols. The specific order of addition and the reaction temperature can determine the physical properties of the resulting resin. For example, if macrocyclic ethylene isophthalate dimer is added with all of the other resin components and the mixture heated to typical polyesterification conditions of 230-250° C., a random co-polyester will be obtained, i.e. the sequence of acid and polyol units along the polymer chain is not ordered but is random. However, if the macrocyclic ethylene isophthalate dimer is added to a polyester oligomer or prepolymer at a temperature of 160-190° C., scrambling or randomizing of the ethylene isophthalate unit is minimized and the resulting resin will contain significant lengths of consecutive ethylene isophthalate units, i.e. the resin will have a degree of “blockiness”. Those skilled in the art will recognize that block copolymers and random copolymers exhibit quite different physical properties, such as solvent resistance, solubility, impact resistance, hardness, flexibility, tensile strength, etc.

Those skilled in the art will recognize that similar approaches can be used to prepare resins comprising isophthalic units that are useful for formulating many solvent-borne coatings, alkyd coatings, and waterborne coatings.

### Example 3

### Polyester-Urethane Coating for Wood Resin

Polyester-Urethane Coating for Wood Resin

| Materials | Parts by weight | Moles |
|---|---|---|
| Neopentyl glycol | 371.3 | 3.57 |
| macrocyclic ethylene | 292 | 0.76 |
| isophthalate dimer | | |
| Trimellitic anhydride | 100.9 | 0.526 |
| Adipic acid | 250.6 | 1.716 |

Neopentyl glycol, adipic acid, and macrocyclic ethylene isophthalate dimer are charged to a reactor equipped with agitator, inert gas sparge, thermometer, and appropriate partial condenser (such as a steam heated partial condenser and water cooled total condenser). The contents are heated slowly to about 225° C. and the held at this temperature until an acid number <10 is reached. The contents are cooled to 175° C. and trimellitic anhydride is charged to the reactor. The reaction mixture is reheated to about 230-250° C. until an acid number <10 is obtained. The resin is cooled to 135° C. and thinned to 80% NVM (non-volatile material) with n-butyl acetate.

The polyester wood Resin 3 is formulated into a two-component high solids polyurethane coating. Component 1 comprises 141.1 parts Resin 3 (at 80% NVM), 30.4 parts n-butyl acetate, 14.5 parts ethyl acetate, 33.7 parts ethyl-3-ethoxyproprionate, and 0.5 parts of a flow agent (e.g. Dow Corning DC-11). Component 2 comprises Desmodur N-3390 (an aliphatic polyisocyanate resin based on hexamethylene diisocyanate (HDI), a product of Bayer Material Science) 30.1 parts, Desmodur HL (an aliphatic/aromatic polyisocyanate copolymer based on toluene diisocyanate (TDI) and hexamethylene diisocyanate (HDI) from Bayer Material Science) 45 parts, and ethyl acetate 15.2 parts.

### Example 4

### High Solids Bake Alkyd Resin

High Solids Bake Alkyd Resin 4

| Materials | Parts by weight | Moles |
|---|---|---|
| Soya fatty acids | 390.4 | |
| Trimethyolpropane | 183.7 | 1.36 |
| macrocyclic ethylene | 296 | 0.77 |
| isophthalate dimer | | |
| Isophthalic acid | 113.0 | 0.68 |

An alkyd resin is a condensation product involving a polybasic acid with a polyhydric alcohol with the addition of modifying agents such as higher fatty acids. More specifically, an alkyd resin is the esterification product of dibasic acids with polyols, monobasic carboxylic acids or vegetable oil precursors thereof, including saturated and unsaturated fatty acids having between 10 and 22 carbon atoms and monobasic aromatic acids, and a tricarboxylic acid or anhydride. Esterification catalysts can be used in preparing the alkyd. Macrocyclic ethylene isophthalate dimer can be used to facilitate the preparation of alkyd resins.

The fatty acids, trimethylolpropane, and macrocyclic ethylene isophthalate dimer are charged to a reactor equipped with agitator, inert gas sparge, thermometer, and appropriate partial condenser (such as a steam heated partial condenser and water cooled total condenser). The contents are heated and processed at a maximum reactor temperature of about 230-240° C. and overhead temperature of 100° C. until an acid number <10 is reached. The reactor contents are cooled to about 180° C. and isophthalic acid is charged. The contents are again heated and processed at a maximum reactor temperature of about 230-240° C. and overhead temperature of 100° C. until an acid number <10 is reached. The resin is cooled to about 90° C. and thinned to approximately 80% NVM with methyl isobutyl ketone.

Resin (340.8 parts), pigment (225.8 parts titanium dioxide, such as Ti-pure R-900 available from DuPont Titanium Technologies), flow agent (2.0 parts, FC-430 from 3M), and ethyle-3-ethoxypropionate (31.4 parts) are charged to a high speed disperser and ground to a #7 Hegman Grind. To this mixture is then added 70.5 parts hexamethoxymethyl melamine (such as Cymel 303 from Cytec Industries), 0.6 parts surfactant (Surfynol® 465 from Air Products and Chemicals), 11.5 parts dodecylbenzene sulfonic acid blocked catalyst (such as NaCure from King Industries), 68 parts methyl ethyl ketone, 2.0 parts methyl ethyl ketoxime anti-skin agent (such as Exkin #2 from Condea Servo), and 0.8 parts drier (18% cobalt). This alkyd bake enamel is then thinned to an appropriate final spray viscosity with solvent.

### Example 5

### Aqueous Polyurethane Dispersion Resin

Aqueous Polyurethane Dispersion
Polyester Diol Resin 5

| Materials | Parts by weight | Moles |
|---|---|---|
| 1,6-Hexanediol | 127.4 | 1.08 |
| Adipic acid | 109.5 | 0.75 |
| macrocyclic ethylene | 48 | 0.125 |
| isophthalate dimer | | |

All materials are charged to a reactor equipped with agitator, inert gas sparge, thermometer, and appropriate partial condenser (such as a steam heated partial condenser and water cooled total condenser). The contents are heated with agitation to a maximum reaction temperature of about 220-230° C. while maintaining an overhead temperature of 100° C. The resin is discharged from the reactor when the acid value reaches 1.5-2.0.

A variation of Polyester Diol Resin 5 can be prepared by following the above procedure but initially, charging only 1,6-hexanediol and adipic acid. When an acid value of 1.5-2.0 is reached, the reactor is cooled to about 170-180° C. The macrocyclic ethylene isophthalate dimer is charged and the reaction temperature is maintained until macrocyclic ethylene isophthalate dimer is incorporated into the resin. The resin is then discharged from the reactor. This resin will exhibit blockiness and should have a greater ethylene isophthalate character on each end of the polymer chains compared to the resin prepared when all ingredients are added at once. This blockiness will be similar to an ABA-type block copolymer with hard A blocks and a soft, flexible center B segment. It is expected that these two variations of Polyester Diol Resin 5 will show different performance properties when formulated into a coatings as described below.

The polyester diol prepared above is then used to make an isocyanate terminated prepolymer. To a reactor equipped with agitator, inert gas sparge, thermometer, and appropriate partial condenser (such as a steam heated partial condenser and water cooled total condenser) are charged 324.6 parts of the polyester diol, 367.9 parts N-methyl-2-pyrrolidone, 278.8 parts dicyclohexylmethane-4,4′-diisocyanate, 28.7 parts dimethylolpropionic acid, and 0.08 parts dibutyltin dilaurate. The mixture is heated with agitation to 85° C. for 4 hours. The solution is then checked for the presence of an hydroxyl peaks at 3450-3500 cm⁻¹ in the infrared spectrum. If the spectrum shows the presence of hydroxyl, the reactor contents are heated slowly to 100° C. until the hydroxyl peak disappears. The isocyanate terminated prepolymer is cooled to room temperature and 430.4 parts transferred to a steel container equipped with a high speed disperser (similar to a pigment disperser). High speed agitation is initiated and, in quick succession, 21.9 parts 50/50 triethyl amine/deionized water, 508.2 parts deionized water, and 24.7 parts 2-methylpentamethylenediamine are added. The addition of 2-methylpentamethylenediamine may result in a sudden increase in viscosity and should be added slowly to maintain a constant vortex. Add 14.8 parts N-methyl-2pyrrolidone and continue high speed agitation for about 20 minutes.

### Example 6

### Waterborne Bake Alkyd Resin

Waterborne Bake Alkyd Resin 6

| Materials | Parts by weight | Moles |
|---|---|---|
| Trimellitic anhydride | 240 | 1.25 |
| Neopentyl glycol | 260 | 2.50 |
| macrocyclic ethylene | 160 | 0.415 |
| isophthalate dimer | | |
| Tall oil fatty acid¹ | 356 | |

¹Sylfat ® FA1 from Arizona Chemical

Charge neopentyl glycol, macrocyclic ethylene isophthalate dimer, and 141.6 parts of the trimellitic anhydride to a reactor equipped with agitator, inert gas sparge, thermometer, and appropriate partial condenser (such as a steam heated partial condenser and water cooled total condenser). The reactants are slowly heated to 235° C.; agitation is started as soon as the mixture can be stirred. A maximum overhead temperature of about 100-102° C. is maintained and heating is continued until an acid number <10 is reached. The tall oil fatty acid is charged and the temperature is held at 220-227° C. until the acid number is <10 and a Gardner-Holdt viscosity of T+at 80% NVM in butoxyethanol is obtained. The reactor is cooled to about 205-210° C. and the remaining trimellitic anhydride is added. The reactor is held at 205-210° C. until the acid becomes about 35-37. The reactor contents are reduced to 75% NVM with butoxyethanol and filtered.

To a mixing vessel, charge 290.4 parts of the above resin solution in butoxyethanol (75% NVM), 11.2 parts dimethylethanolamine, and 400.6 parts deionized water. This aqueous resin solution is then charged to a pebble mill along with 258.4 parts titanium dioxide and 39.4 parts amino crosslinker (Cymel® 301 from Cytec Industries) and milled to a Hegman Grind of 7+. After milling, the pH and viscosity is adjusted as necessary pH 7.65 and #4 Ford cup viscosity of 55 seconds.

### Example 7

### Polyester Resin for Coil Coating Resin

Polyester Resin for Coil Coating Resin 7

| Materials | Parts by weight | Moles |
|---|---|---|
| 1,6-Hexanediol | 129.8 | 1.10 |
| Neopentyl glycol | 166.4 | 1.60 |
| Adipic acid | 86.9 | 0.595 |
| macrocyclic ethylene | 324 | 0.843 |
| isophthalate dimer | | |
| Terephthalic acid | 280.1 | 1.686 |
| Trimellitic anhydride | 26.7 | 0.1391 |
| Catalyst FASCAT 2100¹ | 0.6 | |

Butylstannoic acid, available from Arkema, Inc.

Neopentyl glycol and hexanediol are charged to a reactor equipped with agitator, inert gas sparge, thermometer, and appropriate partial condenser (such as a steam heated partial condenser and water cooled total condenser). The contents are slowly heated under a nitrogen sparge and agitation is started as soon as possible. The contents are heated to about 100-120° C. and then the adipic acid, terephthalic acid, and trimellitic anhydride are slowly added while maintaining a slurry of materials in the reactor. The temperature is slowly raised to 230-240° C. Catalyst is added when the temperature reaches about 140° C. Heating is continued until the acid number is about 7-9. The reaction temperature is then lowered to about 165-185° C. and macrocyclic ethylene isophthalate dimer is added. Heating is continued until macrocyclic ethylene isophthalate dimer has reacted and been incorporated into the resin. The resin is then thinned to 60% NVM with a 3:1 blend of aromatic 150 solvent and propylene glycol monomethyl ether acetate. The solution is cooled to ambient temperature, filtered, and packaged.

This resin will exhibit blockiness in which the ethylene isophthalate character will be found mostly at the ends of the polymer chains. The resin could also be prepared with more randomized distribution of the component monomer units by charging macrocyclic ethylene isophthalate dimer along with the adipic acid, terephthalic acid, and trimellitic anhydride in the above process description.

A coil coating or spray applied coating can be prepared from the above resin. A procedure for a basic white coil coating is described. About 450 parts of the above resin, 30 parts melamine (such as Cymel® 303 from Cytec), and 0.6 parts flow additive (such as FC-430 from 3M) are charged to a high speed mixer. Titanium dioxide (240 parts) are added and dispersed at high speed to obtain a 7+Hegman grind. The mixture is let down with about 278 parts propylene glycol monomethyl ether acetate and 1.5 parts para-toluene sulfonic acid (50% in isopropanol) are added.

### Example 8

### Multi-Armed “Star” El-Polyester Resins

Multi-armed, “star” polymers can also be prepared from macrocyclic ethylene isophthalate dimer. The star polymers are formed from an initiator molecule that can be either a multi-functional carboxylic acid or a multi-functional polyol. A tri-functional initiator will produce a three-armed star polymer; a tetra-functional initiator molecule will lead to a four-armed star, etc. Representative multi-functional carboxylic acids include (without limitation): trimellitic acid; trimesic acid; and pyromellitic acid. Representative multi-functional polyols include (without limitation): trimethylolethane; trimethylolpropane; pentaerythritol; and di-pentaerythritol. It is recognized that the multi-functional polyols can also include the products obtained from reaction of a multi-functional polyol with, for example, ethylene oxide and, thus, extending the arms of the polyol with —CH₂CH₂O— units. Both ethoxylated and propoxylated multifunctional polyols are potential initiator molecules. The multi-armed star polyester will be carboxyl functional if the initiator is a multi-functional carboxylic acid and the star polyester will be hydroxyl functional if the initiator is a multi-functional polyol.

### Hydroxyl Functional El-Polyester Star Resin 8:

Hydroxyl Functional EI-Polyester Star Resin 8

| Materials | Parts by weight | Moles |
|---|---|---|
| Trimethylolpropane | 134.17 | 1 |
| macrocyclic ethylene | 3843.4 | 10 |
| isophthalate dimer | | |
| Catalyst butylstannoic acid | 1.0 | |

Trimethylolpropane is charged to a reactor equipped with an agitator, inert gas sparge, thermometer, and appropriate partial condenser (such as a steam heated partial condenser and water cooled total condenser). The contents are slowly heated under a nitrogen sparge and agitation is started as soon as possible. The contents are heated to about 100-120° C. and the butylstannoic acid catalyst is added. The reactor is heated to about 175-195° C. and about 10% of the macrocyclic ethylene isophthalate dimer is added. As the macrocyclic ethylene isophthalate dimer dissolved and reacted, more macrocyclic ethylene isophthalate dimer is added. The growing polyester star is a good solvent for macrocyclic ethylene isophthalate dimer and the macrocyclic ethylene isophthalate dimer can be added faster as the polymerization proceeds. The reaction temperature can be adjusted as necessary to maintain stirring/agitation. When all macrocyclic ethylene isophthalate dimer is incorporated into the resin, the mixture is discharged from the reactor, and the resin product is cooled, and flaked or ground. Higher molecular weight resin may be extruded and formed into pellets. The molecular weight of the star resin can be controlled by the ratio of macrocyclic ethylene isophthalate dimer to initiator molecule (trimethylolpropane in this example); a higher ratio affords a resin with a higher molecular weight. Other variations include the use of tetra- and hexa-functional initiator polyol molecules to produce 4 and 6-armed stars.

These hydroxyl functional polyester star resins can be used as binder resin in a powder coating crosslinked with a blocked isocyanate. These star resins may also be used as flow additives in coating formulations. Other applications of these novel star resins include use (either neat or as a blend with other polymers) as a thermoplastic for fabrication of various articles including films, containers, and bottles. Improved barrier performance compared to conventional polyesters such as PET and PBT is anticipated.

### Carboxyl Functional EI-Polyester Star Resin:

Carboxyl Functional EI-Polyester Star Resin 8

| Materials | Parts by weight | Moles |
|---|---|---|
| Trimesic acid | 210.14 | 1 |
| macrocyclic ethylene | 3843.4 | 10 |
| isophthalate dimer | | |
| Catalyst Dibutyltin diacetate | 1.0 | |

Trimesic acid, dibutyltin diacetate catalyst, and about 10,000 parts N-methyl-2-pyrrolidone are charged to a reactor equipped with an agitator, inert gas sparge, thermometer, and appropriate partial condenser (such as a steam heated partial condenser and water cooled total condenser). The contents are stirred and slowly heated to about 200° C. under a nitrogen sparge and about 10% of the macrocyclic ethylene isophthalate dimer is added. As the macrocyclic ethylene isophthalate dimer dissolved and reacted, more macrocyclic ethylene isophthalate dimer is added. The growing polyester star is a good solvent for macrocyclic ethylene isophthalate dimer and the macrocyclic ethylene isophthalate dimer can be added faster as the polymerization proceeds. Reaction temperature is maintained until all macrocyclic ethylene isophthalate dimer is incorporated into the resin. The reaction solution is cooled to ambient temperature and then discharged into stirred container of deionized water. The product polymer is collected by filtration and subsequently thoroughly washed several times with water, methanol, or water/methanol mix. The polymer is then dried. The molecular weight of the star resin can be controlled by the ratio of macrocyclic ethylene isophthalate dimer to initiator molecule (trimesic acid in this example); a higher ratio affords a resin with a higher molecular weight. Other variations include the use of tetra-functional initiator carboxylic acid molecules to produce 4-armed stars.

### Examples 9-12

### Unsaturated Polyesters Based on Macrocyclic Ethylene Isophthalate Dimer

A versatile family of thermosetting materials known as unsaturated polyester resins comprises low molecular weight polyester polymers derived from unsaturated dibasic acids and/or anhydrides dissolved in unsaturated vinyl monomers. Unsaturated polyester resins are used in conjunction with glass fiber or carbon fiber reinforcement to form laminar composites. The resins are also used in casting processes that contain high loadings of fillers or mineral aggregate. Reactivity fundamental to the majority of commercial resins is derived from maleic anhydride as the unsaturated component in the polyester resin, and styrene as the diluent and co-reactant monomer. Resins containing isophthalic units are widely used in products employing high temperature forming processes. Substitution of isophthalic acid for phthalic anhydride provides enhanced mechanical and thermal performance, greater UV and hydrolytic resistance, and improved resistance to corrosive environments, which are significant properties for a variety of products including underground gasoline storage tanks and large diameter sewer and water pipes. Macrocyclic ethylene isophthalate dimer can be used to facilitate the preparation of unsaturated polyester resins.

Four representative unsaturated polyester formulations are presented below. Resin 9 could be used in applications requiring good chemical resistance (water pipes, underground storage tanks), Resin 10 could be used in sheet molding compound, Resin 11 could be used in pultrusion fabrication (ladder rails, structural “I” beams), and Resin 12 could be used a high quality gel coat.

Unsaturated Polyesters Based on macrocyclic ethylene isophthalate dimer

| | Resin 9 | | Resin 10 | | Resin 11 | | Resin 12 | |
|---|---|---|---|---|---|---|---|---|
| Monomer | Moles | Weight | Moles | Weight | Moles | Weight | Moles | Weight |
| macrocyclic | 0.5 | 192.2 | 0.5 | 192.2 | 0.5 | 192.2 | 0.5 | 192.2 |
| ethylene | | | | | | | | |
| isophthalate | | | | | | | | |
| dimer | | | | | | | | |
| Propylene | 1.2 | 91.3 | 2.0 | 152.2 | 1.45 | 110.3 | | |
| glycol | | | | | | | | |
| Dipropylene | | | 1.2 | 161.0 | | | | |
| glycol | | | | | | | | |
| Neopentyl | | | | | | | 1.14 | 118.7 |
| glycol | | | | | | | | |
| Diethylene | | | | | 1.0 | 106.1 | | |
| glycol | | | | | | | | |
| Maleic | 1.0 | 98.1 | 3.0 | 294.2 | 2.0 | 196.1 | 1.0 | 98.1 |
| anhydride | | | | | | | | |
| Styrene | | 45% | | 30% | | 30% | | 40% |

The resins shown above can be prepared in a two-stage process.

First Stage: The glycols are charged to a reactor equipped with an agitator, inert gas sparge, thermometer, and appropriate partial condenser (such as a steam heated partial condenser and water cooled total condenser). The contents are heated slowly and the macrocyclic ethylene isophthalate dimer is charged when the temperature is about 50° C. Stirring is maintained along with the inert gas sparge. The reaction temperature is increased to about 180-200° C. and the reaction is continued until the desired acid number is reached (AN<10 for Resin 9; AN 10-15 for Resin 10; AN<30 for Resin 11; AN<10 for Resin 12).

Second Stage: The glycol lost during the first stage processing is determined by analyzing the refractive index of the distillate. Sufficient glycol is then charged to make-up the loss. The reactor is cooled to around 150-155° C. and the maleic anhydride is charged. During the second stage the maximum temperature is held between 210-230° C. Less color is formed when the temperature is kept around 210° C. When esterification is complete (approximate guidelines for the above resins: AN<10 for Resin 9; Gardner-Holdt viscosity of X to Y at 70% solids in inhibited styrene for Resin 10; AN<15 for Resin 11; Gardner-Holdt viscosity of U+at 60% solids in inhibited styrene for Resin 12), the resin is cooled and blended into inhibited styrene (approximate styrene concentration is given in the above Table).

Polymer Modification with Macrocyclic Ethylene Isophthalate Dimer

Macrocyclic ethylene isophthalate dimer can be used to modify polyester polymers such as poly(ethylene terephthalate) (PET), poly(butylene terephthalate) (PBT), poly(ethylene naphthalate) (PEN), etc. The polymer to be modified should possess reactive carboxyl (—COOH) or hydroxyl (—OH) end groups. Modification will proceed in either solution or melt phase at temperatures greater than about 160° C. Higher reaction temperatures will give faster reaction rates and quicker modification times. However, if a high degree of ethylene-isophthalate block copolymer is desired, lower modification temperatures (about 140° C. to about 220° C.) are preferred to minimize randomization of the monomers along the polymer backbone. It is recognized that other polymers besides polyester may be modified by macrocyclic ethylene isophthalate dimer provided these polymers have a reactive end-group (e.g.—COOH, —OH, —NH₂). For example polyamide polymers may be modified in the same manner. Suitable polyamides are nylon 6, nylon 12, or nylon 6,6.

Thus it is apparent that there has been provided, in accordance with the invention, compositions and processes concerning macrocyclic ethylene isophthalate dimer that fully satisfies the objects, aims and advantages set forth above. While the invention has been described in conjunction with specific embodiments thereof, it is evident that many alternatives, modifications, and variations will be apparent to those skilled in the art in light of the foregoing description. Accordingly, it is intended to embrace all such alternatives, modifications, and variations as fall within the spirit and broad scope of the claims.

What is claimed is:

1) A composition comprising: either polyhydric alcohol, or multi-functional carboxylic acid, or both, and macrocyclic ethylene isophthalate dimer.

2) The composition of claim 1, wherein said multi-functional carboxylic acid component is about 4 to about 60 mole %, said polyhydric alcohol is about 4 to about 60 mole %, and said macrocyclic ethylene isophthalate dimer is from about 3 to about 90 mole % of said composition, based on the moles of polyhydric alcohol, multi-functional carboxylic acid and macrocyclic ethylene isophthalate dimer, with the total mole % being 100%.

3) The composition of claim 1, wherein said polyhydric alcohol is selected from the group consisting of dihydric alcohols containing from 2 to 10 carbon atoms; bis-phenol A; 2,2-[bis-(4-hydroxycyclohexyl)]-propane; 2,2-bis-[4-(2-hydroxyethoxy)]-phenylpropane; polyethylene glycol and derivatives thereof; polypropylene glycol and derivatives thereof; trimethylol ethane; trimethylol propane; pentaerythritol; di-pentaerythritol; glycerol, polyethylene oxides; polypropylene oxides; and trimethylol propane polymers; or a mixture of two or more of these.

4) The composition of claim 1, wherein said multi-functional carboxylic acid is selected from the group consisting of aliphatic diacids containing from 4 to 13 carbon atoms; aromatic dicarboxylic acids containing from 8 to 17 carbon atoms; tricarboxylic acids containing from 6 to 13 carbon atoms, and tetracarboxylic acids containing from 8 to 14 carbon atoms; or a mixture of two or more of these.

5) The composition of claim 1, wherein said macrocyclic ethylene isophthalate dimer comprises two isophthalic acid and two ethylene glycol units.

6) The composition of claim 5, wherein said macrocyclic ethylene isophthalate dimer is represented by the formula:

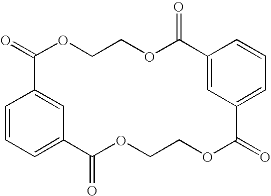

7) The composition of claim 1, wherein said composition also contains catalyst to promote the incorporation of macrocyclic ethylene isophthalate dimer into resins.

8) The composition of claim 7, wherein said catalyst is selected from tin (II), tin (IV), distannoxanes, antimony, or titanium compounds, or a mixture of two or more of these.

9) The composition of claim 1, wherein said composition also contains one or more fatty or other carboxylic acids used to prepare alkyd resins including capric acid, linoleic acid, benzoic acid, dehydrated castor oil fatty acids, heat-bodied soya oil fatty acids, tung oil fatty acids, linseed oil fatty acids, safflower oil fatty acids, soya oil fatty acids, and tall oil fatty acids.

10) A alkyd resin comprising the condensation product of macrocyclic ethylene isophthalate dimer, aliphatic diacids containing from 4 to 13 carbon atoms; and/or aromatic dicarboxylic acids containing from 8 to 17 carbon atoms with polyhydric alcohols, fatty mono-carboxylic acids or vegetable oil precursors thereof including saturated and unsaturated fatty acids having between 10 and 22 carbon atoms, monobasic aromatic acids, and a tricarboxylic acid or anhydride thereof.

11) A process for preparing a composition, comprising:
providing a macrocyclic ethylene isophthalate dimer having the formula 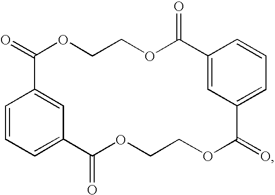
blending said macrocyclic ethylene isophthalate dimer with either polyhydric alcohol or multi-functional carboxylic acid, or both.

12) The process of claim 11, wherein said multi-functional carboxylic acid component is about 4 to about 60 mole %, said polyhydric alcohol is about 4 to about 60 mole %, and said macrocyclic ethylene isophthalate dimer is from about 3 to about 90 mole % of said composition, based on the moles of polyhydric alcohol, multi-functional carboxylic acid and macrocyclic ethylene isophthalate dimer, with the total mole % being 100%.

13) The process of claim 11, wherein said polyhydric alcohol is selected from the group consisting of dihydric alcohols containing from 2 to 10 carbon atoms; bis-phenol A; 2,2-[bis-(4-hydroxycyclohexyl)]-propane; 2,2-bis-[4-(2-hydroxyethoxy)]-phenylpropane; polyethylene glycol and derivatives thereof; polypropylene glycol and derivatives thereof; trimethylol ethane; trimethylol propane; pentaerythritol; di-pentaerythritol; glycerol, polyethylene oxides; polypropylene oxides; and trimethylol propane polymers; or a mixture of two or more of these.

14) The process of claim 11, wherein said multi-functional carboxylic acid is selected from the group consisting of aliphatic diacids containing from 4 to 13 carbon atoms; aromatic dicarboxylic acids containing from 8 to 17 carbon atoms; tricarboxylic acids containing from 6 to 13 carbon atoms, and tetracarboxylic acids containing from 8 to 14 carbon atoms; or a mixture of two or more of these.

15) The process of claim 11, wherein catalyst is mixed with said composition, said catalyst is selected from tin (II), tin (IV), distannoxanes, antimony, or titanium compounds, or a mixture of two or more of these.

16) The process of claim 11, wherein said blending occurs under heated conditions of about 140° C. to about 250° C. and in the presence of inert gas.

17) The process of claim 16, wherein said composition also contains one or more fatty acids.

18) A multi-arm polyester resin having a polymer containing: a central unit of a multi-functional molecule of either a multi-functional carboxylic acid or a multi-functional polyol, but not both and arms derived from macrocyclic ethylene isophthalate dimer.

19) The multi-arm polyester resin of claim 18, wherein said multi-functional carboxylic acid is selected from trimellitic acid, trimesic acid, or pyromellitic acid.

20) The multi-arm polyester resin of claim 18, wherein said multi-functional polyol is selected from the class of trimethylolethane, trimethylolpropane, pentaerythritol or di-pentaerythritol.

21) The multi-arm polyester resin of claim 18, wherein said macrocyclic ethylene isophthalate dimer is present at a mole ratio of about 20 to 1 of the multi-functional molecule.

22) The multi-arm polyester resin of claim 18, wherein said macrocyclic ethylene isophthalate dimer has the formula

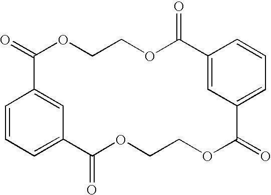

23) A process of preparing a multi-arm polyester resin, comprising: a macrocyclic ethylene isophthalate dimer having the formula 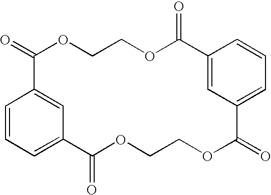
and a multi-functional molecule of either a multi-functional carboxylic acid or a multi-functional polyol, but not both, by blending said dimer and said molecule under heated conditions of at least about 100° C. in an inert gas atmosphere.

24) The process of claim 23, wherein said molecule is a multi-functional carboxylic acid selected from trimellitic acid, trimesic acid, or pyromellitic acid.

25) The process of claim 23, wherein said molecule is a multi-functional polyol selected from the class of trimethylolethane, trimethylolpropane, pentaerythritol or di-pentaerythritol.

26) Unsaturated polyester comprising: a macrocyclic ethylene isophthalate dimer having the formula 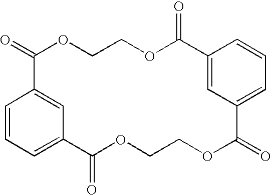
one or more polyhydric alcohols, one or more ethylenically unsaturated dicarboxylic acids, one or more ethylenically unsaturated reactive solvents; and optionally, one or more aliphatic and/or aromatic acids.

27) The unsaturated polyester of claim 26, wherein said polyhydric alcohols are selected from the group consisting of dihydric alcohols containing from 2 to 10 carbon atoms, bis-phenol A, polyethylene glycol and derivatives thereof, polypropylene glycol and derivatives thereof, trimethylol ethane, trimethylol propane, pentaerythritol, di-pentaerythritol, polyethylene oxides, polypropylene oxides, and trimethylol propane polymers.

28) The unsaturated polyester of claim 26, wherein said optional aliphatic and aromatic acids are selected from the group consisting of orthophthalic acid, orthophthalic anhydride, isophthalic acid, terephthalic acid, 1,2-cyclohexane dicarboxylic acid, 1,4-cyclohexane dicarboxylic acid, adipic acid, succinic acid, and succinic anhydride.

29) The unsaturated polyester of claim 26, wherein said ethylenically unsaturated dicarboxylic acids are selected from the group consisting of maleic acid, maleic anhydride, and fumaric acid.

30) The unsaturated polyester of claim 26, wherein said ethylenically unsaturated reactive solvents are selected from the group consisting of styrene, vinyl toluenes, acrylic and methacrylic acid esters, and vinyl esters of carboxylic acids.

31) A process for the manufacture of the unsaturated polyester resin of claim 26 comprising the steps of reacting a macrocyclic ethylene isophthalate dimer having the formula 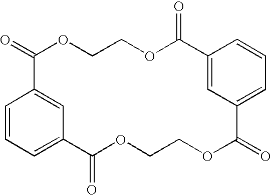
one or more ethylenically unsaturated dicarboxylic acids, one or more polyhydric alcohols, and optionally, one or more aliphatic and/or aromatic acids in a reactor at an elevated temperature of about 140° C. to about 250° C., optionally in the presence of an inhibitor selected from the group consisting of hydroquinone, toluhydroquinone, hydroquinone monomethyl ether,mono-tert-butyl hydroquinone, di-tert-butyl hydroquinone, tri-tert-butyl quinine, and butyl toluhydroquinone and a metal; allowing the reaction to proceed until an acid value of about 1 to 35 mg KOH per gram of unsaturated polyester is reached; and diluting the obtained unsaturated polyester with one or more ethylenically unsaturated reactive solvents.

32) A process for forming a block copolymer, comprising reacting macrocyclic ethylene isophthalate dimer having the formula 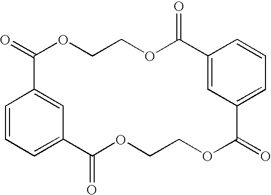
with either polyester or polyamide at a temperature of about 140° C. to about 220° C.

33) The process of claim 32, wherein said polyester is polyethylene terephthalate, polybutylene terephthalate, or polyethylene naphthalate.

34) The process of claim 32, wherein said polyamide is nylon 6, nylon 12, or nylon 6,6.
